(19) United States
(12) Patent Application Publication
(10) Pub. No.: US 2010/0106557 A1
(43) Pub. Date: Apr. 29, 2010

(54) SYSTEM AND METHOD FOR MONITORING REPUTATION CHANGES

(75) Inventor: Duane Fredrick BUSS, West Mountain, UT (US)

Correspondence Address: HAYNES AND BOONE, LLP;IP Section, 2323 Victory Avenue, Suite 700, Dallas, TX, 75219, US

(73) Assignee: NOVELL, INC., Provo, UT (US)

(21) Appl. No.: 12/257,797

(22) Filed: Oct. 24, 2008

(51) Int. Cl. G06F 17/30

(52) U.S. Cl. 705/10

(57) ABSTRACT

System and method for monitoring reputation changes via a reputation system are described. In one embodiment, the method comprises receiving updated reputation information regarding a reputation of interest from a reputation information provider; evaluating the received updated reputation information in accordance with evaluation rules established for the reputation of interest; and providing a notification of results of the evaluating in accordance with notification rules established for the reputation of interest.

### BACKGROUND

The Internet revolution has sparked a host of new communities in which entities may participate. As a result, many transactions that formerly required face-to-face interaction between the transacting parties may now be performed in a virtual space. The Internet has opened new markets to vendors and introduced new means of social interaction to individuals. Individuals may choose to execute business and social transactions within these communities using personas.

As the number of Internet users and transactions have increased, however, so have the number of scams and schemes. As a result, Internet users are becoming increasingly wary of conducting transactions with unknown parties over the Internet. One major factor is the difficulty of tracking the reputation of unknown parties. When a first party interacts with an unknown party, the history of past interactions informs the first party's current expectations with regard to the interaction. Consequently, the possibility of a negative impact on reputation for poor behavior creates an incentive for good behavior.

Many Internet communities have attempted to deal with this issue by providing localized feedback mechanisms, or reputation systems, whereby transacting parties can supply feedback tagged to each other's persona in connection with the transaction. Current reputation systems are adapted to assist consumers in overcoming doubts and hesitations before engaging in specific transactions with unknown parties; however, they do not provide mechanisms for post-transactional monitoring of the transacting parties. For example, assume that after viewing and evaluating the reputation of an unknown online company “widgetsRus.com,” a consumer enters into a buyer/seller type transaction with the company. After the transaction is completed, widgetsRus.com will likely retain and store information about the consumer provided during the transaction. While widgetsRus.com was originally deemed trustworthy by the consumer, based on the pre-transaction reputation of the company, there are many scenarios, such as those involving the company being sold, company management changing, a disgruntled employee, a court order, or a hacker, in which the security of the information of the consumer held by widgetsRus.com could be jeopardized. Therefore, after the consumer releases information to widgetsRus.com, he or she may want to continue to monitor the company to stay apprised of changes in their reputation vis a vis the consumer so that the consumer is at least aware of potential risks to information held by widgetsRus.com.

Additionally, current reputation systems generally display reputation as a average of lifetime ratings. This information is useful if the reputation of the reputation holder has been consistent over time or has experienced just a few anomalies; however, if the reputation holder's reputation is changing rapidly in a positive or negative direction, such historical averages will mask recent events. Users who rely on discovering trends apply complex computations and models to the raw reputation information to discover such trends. Current reputation systems often do not provide access to sufficient information to perform such in-depth analysis.

Moreover, there are situations in which a user may want to discover reputations that are closely related to a reputation of interest. Reputations may be related in a variety of manners. For example, reputations of members of the same family or household are related. These types of relationships are often depicted using social graphs. Additionally, reputations may be related by associative reputation contexts. Reputation contexts may be deemed to be associative if there is a natural or defined affinity between the contexts. A reputation context may be very narrow; for example, a company might be described in one reputation context as a consumer of goods, with specific comments on interactions and payments. The same company may also have other reputation contexts, such as a producer of goods, a consumer of services, etc. Someone who wants to monitor reputation for a company might want to look at several reputation contexts that have some association or affinity.

### SUMMARY

One embodiment is a method of monitoring reputation changes via a reputation system. The method comprises receiving updated reputation information regarding a reputation of interest from a reputation information provider; evaluating the received updated reputation information in accordance with evaluation rules established for the reputation of interest; and providing a notification of results of the evaluating in accordance with notification rules established for the reputation of interest.

### DESCRIPTION OF THE DRAWINGS

FIG. 1 is a block diagram of a system for monitoring reputation changes in accordance with one embodiment.

### DETAILED DESCRIPTION

In general, the embodiments described herein add to an abstracted attested reputation system a user policy controlled application or service capable of maintaining baseline reputation information in connection with a reputation of interest; actively and/or passively gathering incremental reputation updates; applying evaluation functions to the baseline reputation information and the reputation updates; and providing notifications based on results of the applied evaluation functions.

One embodiment is a reputation system that enables a primary entity to create an interest list comprising a list of reputations of interest that the primary entity desires to monitor. In particular, the interest list is a cache of reputations in which a user has an interest. The interest list may be local or remote and may form a part of a reputation information provider (described below).

As used herein, a “reputation of interest” refers to the reputation of a secondary entity (typically an entity with which the primary entity has participated in transactions) in a particular context. Examples of context include, but are not limited to, social, professional, financial, identity, skill. Moreover, within each broad context, there may also be one or more identifiable subcontexts. For each reputation of interest, the interest list includes a reputation identifier and one or more baseline indicators for use in reputation evaluation and monitoring functions. As used herein, a “reputation identifier” identifies in some form (e.g., by identity of the secondary entity and relevant context) the reputation of interest. A “baseline indicator” identifies, either directly or indirectly, baseline reputation information of the reputation of interest that serves as a basis for comparison with updated reputation information obtained from a reputation information provider in evaluating changes in the reputation of interest over time. Baseline indicators help identify, limit, constrain, and version the reputation forming information used in constructing the reputation. Baseline reputation information may be stored directly in the interest list or may be provided by the reputation information provider, which, in addition to storing baseline reputation information, may allow for conditional access for read, update, signing, and other established reputation operations.

The reputation identifier may refer to a single reputation or set of reputations, a particular reputation engine evaluation output, given a specific set of inputs (“baseline indicators”), a set of ontologically similar reputations, or rules for finding ontologically similar reputations. The identifier may be specific to a reputation information provider or might cross reputation information providers.

For purposes that will be described in greater detail below, for each reputation of interest in the interest list, evaluation and notification rules to be used by a reputation computation engine in evaluating changes in reputation (compared to the baseline reputation information) and determining whether and in what manner to notify the primary entity of such changes may be specified.

In particular, in one embodiment, baseline reputation information identified by a baseline indicator for a reputation of interest in the interest list is compared by the reputation computation engine to reputation updates for the reputation of interest provided by one or more reputation information providers to compute relevant changes in the reputation (“reputation deltas”). The reputation deltas may be evaluated in accordance with the relevant evaluation rules, which include one or more user-selected and user-defined evaluation functions, to detect trends or changes in the secondary entity's reputation.

In one aspect, in addition to noting trends or changes in reputation, embodiments described herein may, where appropriate, provide remediation data with the reputation deltas, such that there is a clear plan of action in dealing with a secondary entity whose reputation of interest has declined to an unacceptable level. In this regard, previously existing reputation systems are extended to include versioned updates that may include metadata. Such metadata provides a means for tagging reputation changes with critical information for interested parties, such as potential remediation mechanisms. The primary entity is also notified of reputation deltas in accordance with the applicable notification rules. In another aspect, certain embodiments enable related reputations in the form of hard references or social graphs to be used in discovering other, related, reputations of interest that a user may also want to monitor.

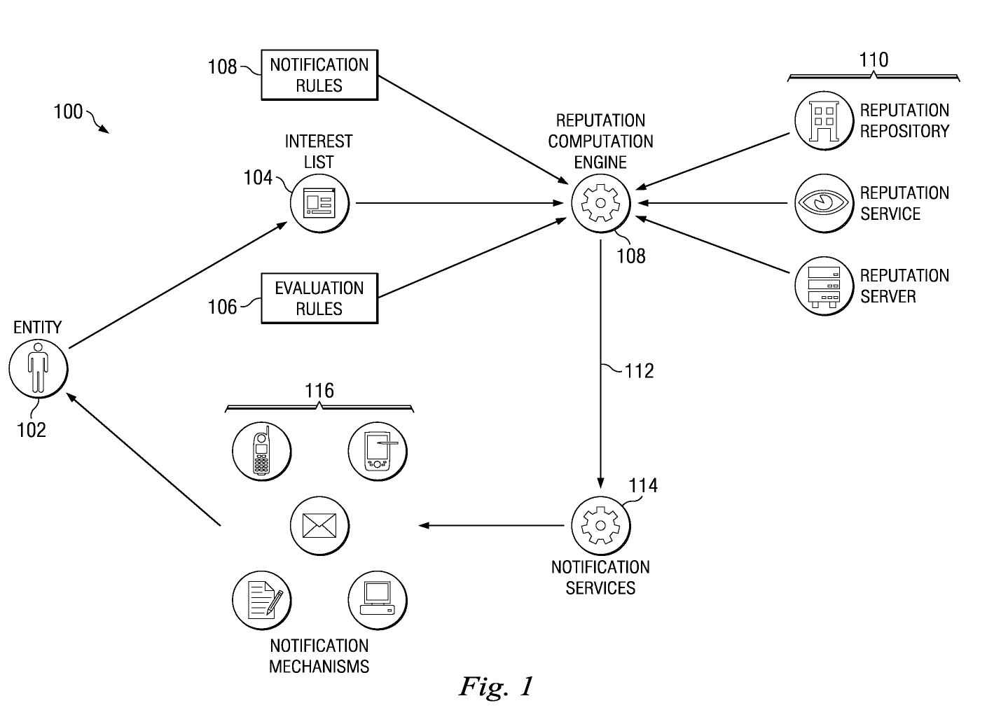

FIG. 1 is a system 100 for monitoring reputation changes in accordance with one embodiment. As shown in FIG. 1, as a primary entity 102 interacts with a secondary entity, the primary entity may choose to add to an interest list 104 (via, for example, a user interface (“UI”) of the primary entity) a reputation identifier corresponding to the secondary entity. At that point, or at some later time, a baseline identifier corresponding to the reputation identifier may also be added to the interest list 104. Additionally, for each reputation identifier of the interest list 104 a user may select and/or define evaluation rules 106 and notification rules 108 for purposes that will be described in greater detail below.

A reputation computation engine 108 applies evaluation functions in accordance with the evaluation rules 106 to reputation baseline information identified in the interest list 104 and reputation updates from one or more reputation information providers 110. The reputation information providers 110 may include one or more of any combination of a Reputation Repository, a Reputation Service, and a Reputation Server.

A Reputation Repository is a service that stores reputation forming information, changes, deltas, remediation, and supplemental information. Ideally, based on proper permissions, all of the reputation forming information and deltas would be accessible to a reputation evaluation engine. A Reputation Service is a service that translates from common information to a visual representation of reputation. One example is processes that use semantic processing to translate blog posts, or message board entries, or twitter feed about people/product to reputation forming information, the output from which could be used as reputation forming information in a reputation repository. Other examples include a process that converts the results of a poll, such as “The Worst Company in America,” to a ranking reputation, and a web site scraper that evaluates local jail or arrest records and associates them with identity. A Reputation Server uses the repository or service often in conjunction with a reputation evaluation engine to present a summarized reputation, without all of the reputation forming information, deltas, etc. A Reputation Server might provide snapshots such as reputation on a particular date versus a current reputation.

In one embodiment, the reputation computation engine 108 comprises a computer that includes a computer-readable medium (such as, for example, a hard disk drive or a CD-ROM) having stored thereon computer-executable instructions for causing the reputation computation engine 108 to perform the functions described herein. The reputation information providers may include a variety of both static reputation providers, such as, for example, reputation repositories, and more dynamic reputation providers, such as, for example, reputation services, to evaluate for trends and changes in the reputation of interest of a secondary entity. Examples of possible evaluation rules include, but are not limited to:
Compare baseline reputation information identified in the interest list to current reputation information provided by a reputation service and trigger on specified reputation changes, such as a case in which the current reputation information is 10% lower (i.e., less positive/more negative) than the baseline reputation information.
For a particular reputation identifier in the interest list, retrieve all reputation forming information within a specified time interval, evaluate the retrieved reputation forming information, and notify the user of the evaluation results.
For a particular reputation identifier in the interest list, determine whether there are one or more families of related reputations that should be evaluated for the same entity and retrieve and evaluate all such related reputations. For example, an entity's reputation as a seller might be saved in the interest list, but this rule would require that the entity should be monitored for all reputation contexts in the data security family as well.
For a particular reputation identifier in the interest list, retrieve reputation information for the identified reputation from more than one reputation information provider and evaluate the retrieved information for discrepancies. Retrieved reputation information may be weighted based on the reputation service from which it was provided, with reputation information provided by more trusted reputation services carrying more weight that reputation information provided by less trusted reputation information providers.

Some rules are dependent on the context of the reputation and reputation service functionality; for example, some reputation services will allow access to versions of reputation forming information, while others will not. It is envisioned that often, more than one rule set might be evaluated. If the result of the evaluation in accordance with the evaluation rules 106 triggers a notification action, a notification services module 114 informs the entity 102 of the reputation change via one or more of several notification mechanisms 116, as specified by the notification rules 108. It will be recognized that the notification mechanisms 116 may include phone, text message, fax, RSS, Atom feed, and email, among others.

In one embodiment, new entries may be added to the interest list 104 in a variety of ways. For example, a user interface of the primary entity 102 may detect a transaction between the primary entity and a secondary entity and prompt the primary entity to add a reputation identifier for the secondary entity (in the context of the just-completed transaction) to the interest list. This could be implemented via a browser plug-in that watches for form submission, a process that watches transactions in a (personal) finance system, and/or a processes that watches a user's blog or twitter feed for people upon whom the user is commenting.

Additionally, a dedicated user interface may be provided at the primary entity that allows addition of new reputations of interest to the interest list and enables discovery of other related public reputations for that same entity. In this scenario, the discovered related reputations might be subordinate to the main reputation and as such be subject to different removal rules, which are specified within the interest list 104. Still further, tools may be provided at the primary entity 102 that glean information from existing social graph fragments, such as LinkedIn, Plaxio, Facebook, foaf, and email address books, for example.

For example, some social graphs include for an entity an indication of associated entities comprising friends or associates of the primary entity. Additionally, there may be included for each associated entity an indication of “degree of separation” with respect to the primary entity and associated entity. In particular, an associated entity may be a family member of the primary entity or may have been designated as a “close friend” of the primary entity. Using this example, it may be desirable to use such social graphs to identify for a primary entity associated entities who have a particular degree of separation with respect to the primary entity and therefore may have a reputation of interest. These identified associated entities may also be added to the interest list and monitored in the same way as the primary entity.

Similarly, there may also exist ontologically similar reputations of interest for an entity that a user might want to monitor via the interest list and reputation computation engine. This may be accomplished by specifying certain types or elements of ontologically similar reputations the user would like to monitor for all entities or for a particular entity individually. For example, assuming a user is monitoring the reputation of a seller based on a first version of available reputation forming information (such as a star rating system) and later a second version of available reputation forming information (such as a ranking with respect to peers) may become available. It is anticipated that the user may also want to monitor the similar reputation based on the second version. The ability to monitor ontologically similar reputations of interest enables this to be accomplished.

In addition to providing at a UI at the primary entity to enable addition of reputations of interest to the interest list, in one embodiment, another UI is provided that enables a user to configure such things as the interest list 104, notification rules 108 and evaluation rules 106, thereby enabling the user to configure operation of the entire system 100, including, but not limited to, which reputation information providers to query, reputation services to query, notification mechanisms, control of association between the reputations and rules used for computation of reputation change, families of related reputations, etc.

Although the reputation computation engine 108 and the reputation information providers 110 are illustrated in FIG. 1 as comprising distinct elements, there is no requirement that this be the case. Additionally, in addition to providing reputation information in response to a request from the reputation computation engine 108, one or more of the reputation information providers might proactively (i.e., absent a request from the reputation computation engine) provide the reputation computation engine with real-time notification of changes in the reputations of entities identified in the interest list 104. Accordingly, the reputation computation engine 108 works off events from one or more of the reputation information providers 110 or polls the reputation information providers 110.

Other features and functionalities enabled by one or more of the embodiments described herein include the ability to build a cache of reputations the user is interested in tracking (via the interest list 104), using global or per-identity/per-reputation evaluation and notification rules to specify triggers and alerts based on reputation changes; triggering based on complex calculations, such as rate of change, deviance from a specified value, for example; discovering reputations with a specified degree of separation from a reputation identified in the interest list and adding those reputations to the interest list; and discovering reputations for the same entity, but within a different context, as a reputation identified in the interest list and adding those reputations to the interest list. In one embodiment, the primary entity 102 includes a UI that enables a user to query the system 100 to view and evaluate changes in reputation over time.

Additionally, as previously mentioned, metadata provides a means for tagging reputation changes with critical information for interested parties, such as potential remediation mechanisms. This enables a user to set a milestone in reputation information such that, once the milestone is met, remediation is performed in accordance with established remediation rules. For example, assuming the user is monitoring a company that has a privacy policy and that the company is purchased by a second company, which changes the privacy policy. The remediation rules in this situation may specify to present one or more options to the user for determining whether the new privacy policy is acceptable and if not, what the options are (e.g., complain to one or more people, visit a particular web site, etc.). Still further, evaluation and notification may be triggered by, for example, a change in reputation. For example, a reputation repository bundled with a reputation service may compute a difference in a monitored reputation and notify the user in a particular manner. This may be performed at the service, as previously described, or may be performed locally on the user's computer.

It will be noted that what constitutes a “party” or an “entity” may vary between embodiments. In one embodiment, the parties may be people interacting with the system. In another embodiment, the parties may be different systems that need to interact in an arm's-length transaction. Another embodiment may use computing modules as parties. Yet another embodiment may use more than one type of entity in the same transaction, i.e., a combination of the above noted exemplary entities. It will be recognized that transactions may have many participating entities.

It is understood that several modifications, changes and substitutions are intended in the foregoing disclosure and in some instances some features of the embodiments will be employed without a corresponding use of other features. Accordingly, it is appropriate that the appended claims be construed broadly and in a manner consistent with the scope of the embodiments described herein.

Although the present disclosure has described embodiments relating to specific commodity environments, it is understood that the apparatus, systems and methods described herein could applied to other environments.

Any spatial references used herein, such as, “upper,” “lower,” “above,” “below,” “between,” “vertical,” “horizontal,” “angular,” “upward,” “downward,” “side-to-side,” “left-to-right,” “right-to-left,” “top-to-bottom,” “bottom-to-top,” “left,” “right,” etc., are for the purpose of illustration only and do not limit the specific orientation or location of the structure described above. Additionally, in several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

What is claimed is:

1. A method of enabling a primary entity to monitor reputation changes via a reputation system, the method comprising:
receiving updated reputation information regarding a reputation of interest from a reputation information provider;
evaluating the received updated reputation information in accordance with evaluation rules established for the reputation of interest;
providing a notification of results of the evaluating in accordance with notification rules established for the reputation of interest.

2. The method of claim 1 further comprising initiating remedial actions responsive to the evaluating in accordance with remediation rules established for the reputation of interest.

3. The method of claim 1 wherein the reputation of interest is identified by an entry in an interest list established by the primary entity.

4. The method of claim 3 further comprising:
discovering a reputation related to the reputation of interest; and
adding the discovered related reputation to the interest list.

5. The method of claim 4 wherein the reputation of interest comprises a reputation of a secondary entity in a first context and wherein the discovered reputation comprises a reputation of the secondary entity in a second context.

6. The method of claim 4 wherein the reputation of interest comprises a reputation of a first secondary entity and the discovered reputation comprises a reputation of a second secondary entity, wherein the first and second secondary entities are related.

7. The method of claim 1 wherein the receiving is performed responsive to a request from an evaluation engine.

8. The method of claim 1 wherein the receiving is initiated by the reputation information provider.

9. An computer program product for enabling a primary entity to monitor reputation changes via a reputation system, the computer program product comprising:
a computer-readable medium; and
instructions stored on the computer-readable medium for causing the computer to:
upon receipt of updated reputation information regarding a reputation of interest from a reputation information provider, evaluate the received updated reputation information in accordance with evaluation rules established for the reputation of interest; and
provide a notification of results of the evaluating in accordance with notification rules established for the reputation of interest.

10. The computer program product of claim 9 further comprising instructions for initiating remedial actions responsive to the evaluating in accordance with remediation rules established for the reputation of interest.

11. The computer program product of claim 9 wherein the computer-readable medium further has stored thereon instructions for causing the computer to receive an interest list from the primary entity, the interest list identifying the reputation of interest and the evaluation rules and notification rules established for the reputation of interest.

12. The computer program product of claim 11 wherein the computer-readable medium further has stored thereon instructions for causing the computer to:
discover a reputation related to the reputation of interest; and
add the discovered related reputation to the interest list.

13. The computer program product of claim 9 wherein the computer-readable medium further has stored thereon instructions for causing the computer to request the updated reputation information from the reputation information provider.

14. A reputation system for enabling a primary entity to monitor changes in a reputation of interest, the system comprising:
a reputation information provider for providing updated reputation information regarding a reputation of interest;
a reputation computation engine for receiving the updated reputation information regarding the reputation of interest and for evaluating the received updated reputation information in accordance with evaluation rules established for the reputation of interest; and
at least one notification mechanism for providing notification of results of the evaluating in accordance with notification rules established for the reputation of interest.

15. The system of claim 14 wherein the reputation computation engine initiates remedial actions responsive to the evaluating in accordance with remediation rules established for the reputation of interest.

16. The system of claim 14 wherein the reputation of interest is identified by an entry in an interest list established by the primary entity and provided to the reputation computation engine.

17. The system of claim 16 wherein the reputation computation engine is adapted to discover a reputation related to the reputation of interest and add the discovered related reputation to the interest list.

18. The system of claim 14 wherein the reputation information provider provides updated reputation information to the reputation computation engine responsive to a request from the reputation computation engine.

19. The system of claim 14 wherein the reputation information provider provides updated reputation information to the reputation computation engine proactively.

20. The system of claim 14 wherein the notification mechanism is selected from a group of notification mechanisms consisting of telephone, e-mail, text message, and facsimile communication.
